(19) United States
(12) Patent Application Publication
(10) Pub. No.: US 2009/0271796 A1
(43) Pub. Date: Oct. 29, 2009

(54) INFORMATION PROCESSING SYSTEM AND TASK EXECUTION CONTROL METHOD

(75) Inventor: Hiroshi KOJIMA, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/425,112

(22) Filed: Apr. 16, 2009

(30) Foreign Application Priority Data
Apr. 25, 2008 (JP) 2008-115152

(51) Int. Cl. G06F 9/46; G06F 13/00

(52) U.S. Cl. 718/103; 718/107; 719/312

(57) ABSTRACT

An information processing system includes a master processor and a slave processor. The master processor operates in a multitasking environment capable of executing request source tasks for making processing requests to the slave processor in parallel by task scheduling based on execution priorities of the tasks. The slave processor operates in a multitasking environment capable of executing a communication processing task and child tasks created by the communication processing task for executing processing requested by the processing requests in parallel by task scheduling. The processing requests contain priority information associated with the execution priorities of the request source tasks in the master processor. The slave processor activates the communication processing task in common for the processing requests from the different request source tasks. The communication processing task creates the child tasks with execution priorities allocated corresponding to the execution priorities of the request source tasks based on the priority information.

### BACKGROUND

1. Field of the Invention

The present invention relates to an information processing system in a multiprocessor configuration. Particularly, the present invention relates to processing sequence control of processing executed in one processor based on processing requests from a plurality of tasks executed in the other processor.

2. Description of Related Art

A processor system which is embedded in transport equipment such as an automobile and an aircraft, communication equipment such as a cellular phone and a switchboard or the like and performs equipment control, signal processing and so on is called an embedded system. The embedded system generally operates in a multitasking environment in order to shorten a processing time, ensure real-time processing, and improve productivity by modularity of software. The multitasking environment is an environment in which a plurality of programs are apparently executed simultaneously by periodically switching tasks to be executed, switching tasks to be executed upon occurrence of an event and so on. The task indicates a unit of program executed in parallel in the multitasking environment. The multitasking environment is implemented by a central processing unit (CPU) and an operating system (OS) that performs scheduling of tasks executed in the CPU. The embedded system is not limited to have a single processor configuration, and it may have a multiprocessor configuration in which a plurality of processors perform master/slave interprocessor communication.

Japanese Unexamined Patent Application Publication No. 60-95676 discloses an information processing system including two CPUs in which the CPUs are connected through an information transfer channel so as to transfer processing requests between the two CPUs, and the CPUs each have a common priority table containing priority information for the respective contents of processing requests. For example, the priority table contains descriptions that a priority “1”, which is the highest priority, is given to “fault handling request”, a priority “2” is given to “command execution request”, and so on. In the case where “fault handling request” is made from one (first) CPU to the other (second) CPU, and “command execution request” is made from the second CPU to the first CPU, the first and second CPUs refer to the respective priority tables and recognize that “fault handling request” has priority over “command execution request”. Accordingly, the first CPU ignores “command execution request” from the second CPU. On the other hand, the second CPU accepts “fault handling request” from the first CPU and starts fault handling.

Japanese Unexamined Patent Application Publications Nos. 6-301655 and 11-312093 disclose distributed processing systems in which a plurality of calculators each operating in a multitasking environment are connected over a network. For example, each calculator included in the distributed processing system disclosed in Japanese Unexamined Patent Application Publication No. 6-301655 has a message transmitting function for intertask communication. A message transmission source task transmits a processing request message that requests processing to another task executed in another calculator. The processing request message contains the priority of the message transmission source task. The calculator of the message receiving end changes a message transmission destination task designated as the destination of the processing request message from wait status to ready status. The execution priority of the message transmission destination task is dynamically determined based on the priority specified in the processing request message. The message transmission destination task is thereby rescheduled by an OS based on the execution priority that is newly determined according to the execution priority of the message transmission source task. Thus, the distributed processing system disclosed in Japanese Unexamined Patent Application Publication No. 6-301655 enables transfer of the execution priority between the tasks executed in different calculators. It is therefore possible to implement efficient task scheduling based on the priority of the message transmission source (e.g. processing request source) task in the calculator to execute a message transmission destination (e.g. processing request destination) task.

### SUMMARY

The present inventors, however, have found the following problem. Consider the case where, in the multiprocessor embedded system with a master processor and a slave processor, the master processor operates in a multitasking environment. In this case, when a plurality of tasks executed in parallel in the master processor concurrently make processing requests to the slave processor, the processing sequence in the slave processor is not based on the task priority in the master processor. Such a problem is described hereinafter specifically with reference to FIG. 8.

FIG. 8 is a view showing the timing when tasks A to D are executed in the master processor operating in a multitasking environment and processing requests are made from the tasks A to D to the slave processor. A communication task executed in the slave processor processes a plurality of processing requests from the master processor one after another according to the received sequence of the requests. In other words, the communication task in FIG. 8 processes a plurality of processing requests by first-in, first-out (FIFO). Accordingly, if a processing request is made at time T4 from the task A, to which a higher execution priority than to the tasks B to D is given, processing OP-A in response to the processing request from the task A is forced to wait until processing OP-C and processing OP-D are completed. The processing OP-C is processing performed in response to a processing request made from the task C at time T2, which is being executed at the time when the processing request is made from the task A. The processing OP-D is processing performed in response to a processing request made from the task D at time T3, which has entered the wait status prior to the processing OP-A.

As described above, in the multiprocessor embedded system, a problem that the task priority in the master processor does not take effect in the slave processor, which is called priority inversion, sometimes occurs. In order to avoid this, those who develop embedded software need to perform design, development and testing based on full understanding of the scheme of interprocessor communication between the master processor and the slave processor, which increases workload for developers.

The technique disclosed in Japanese Unexamined Patent Application Publication No. 60-95676 is effective when processing requests are made simultaneously from the respective CPUs in the case where the master-slave relationship between the two CPUs is eliminated and processing requests are made to each other between the two CPUs. However, the technique of Japanese Unexamined Patent Application Publication No. 60-95676 does not assume the multitasking environment. Therefore, Japanese Unexamined Patent Application Publication No. 60-95676 discloses nothing about, in the case where a plurality of processing requests are made sequentially from a plurality of tasks executed in parallel in one CPU to the other CPU, how to execute processing in response to the plurality of processing requests in the other CPU.

Further, in the distributed processing system disclosed in Japanese Unexamined Patent Application Publication No. 6-301655, the destination of a processing request message is each task to which a processing request is made. Thus, the task to which a processing request is made is previously created and enters the wait status before the processing request is received. Therefore, the technique disclosed in Japanese Unexamined Patent Application Publication No. 6-301655 has a problem that memory resources and OS resources are largely consumed in order to hold the context of the created task. Compared to the distributed processing system that is a target of Japanese Unexamined Patent Application Publication No. 6-301655, which is a calculator system in which a plurality of calculators are connected over a network, the embedded system is subject to larger constraints on memory resources and OS resources due to constraints on a device scale, constraints on a device cost and so on. Therefore, it is difficult to apply the technique disclosed in Japanese Unexamined Patent Application Publication No. 6-301655 to the embedded system.

A first exemplary aspect of an embodiment of the present invention is an information processing system including a master processor and a slave processor. The master processor operates in a multitasking environment capable of executing a plurality of request source tasks for respectively making processing requests to the slave processor in parallel according to task scheduling based on execution priorities of the respective tasks. The slave processor operates in a multitasking environment capable of executing a communication processing task for controlling communication with the master processor and child tasks created by the communication processing task for executing processing requested by the processing requests in parallel according to task scheduling based on execution priorities of the respective tasks. The processing requests contain priority information associated with the execution priorities of the request source tasks in the master processor. The slave processor activates the communication processing task in common in response to the plurality of processing requests made from the plurality of request source tasks different from each other. The communication processing task, which is activated in response to reception of the processing requests, creates the child tasks with execution priorities allocated corresponding to the execution priorities of the request source tasks based on the priority information contained in the processing requests.

As described above, in the information processing system according to the first exemplary aspect of an embodiment of the present invention, the communication processing task activated in the slave processor in response to a processing request from the master processor creates the child tasks to which the execution priorities corresponding to the execution priorities of the request source tasks are dynamically allocated. The execution priorities of the request source tasks in the master processor are thereby given to the child tasks in the slave processor. This enables the slave processor to operate according to the execution priorities of the tasks in the master processor.

Further, in the information processing system according to the first exemplary aspect of an embodiment of the present invention, the communication processing task is activated in common for reception of a plurality of processing requests from a plurality of different request source tasks. Then, the communication processing task creates the child tasks corresponding to the respective processing requests. Thus, the information processing system according to the first exemplary aspect of an embodiment of the present invention does not need to create child tasks corresponding to a plurality of kinds of processing requests in advance in the slave processor. Therefore, in contrast to the distributed processing system disclosed in Japanese Unexamined Patent Application Publication No. 6-301655, the information processing system according to the first exemplary aspect of an embodiment of the present invention can avoid a waste of memory resources and OS resources for saving the task context, thus contributing to reduction of the device scale and the device cost of the embedded system.

According to the exemplary aspect of an embodiment of the present invention described above, it is possible to provide an information processing system in a multiprocessor configuration that enables a slave processor to operate according to the execution priorities of tasks in a master processor and contributes to reduction of the device scale and the device cost of an embedded system.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing an exemplary configuration of an information processing system according to an exemplary embodiment of the present invention;

FIG. 2 is a flowchart showing an operation procedure related to an information processing system according to an exemplary embodiment of the present invention;

FIG. 3 is a view showing an exemplary structure of communication data between processors in an information processing system according to an exemplary embodiment of the present invention;

FIG. 4 is a flowchart showing an operation procedure related to an information processing system according to an exemplary embodiment of the present invention;

FIG. 5 is a flowchart showing an operation procedure related to an information processing system according to an exemplary embodiment of the present invention;

FIG. 6 is a reference view showing a task execution sequence in a virtual single processor device;

FIG. 7 is a view showing a task execution sequence in an information processing system according to an exemplary embodiment of the present invention; and

FIG. 8 is a view showing a task execution sequence in an information processing system according to related art.

### DETAILED DESCRIPTION OF THE EXEMPLARY EMBODIMENTS

An exemplary embodiment of the present invention is described hereinafter in detail with reference to the drawings. The same elements are denoted by the same reference symbols, and the redundant explanation is omitted according to need for simplification of description.

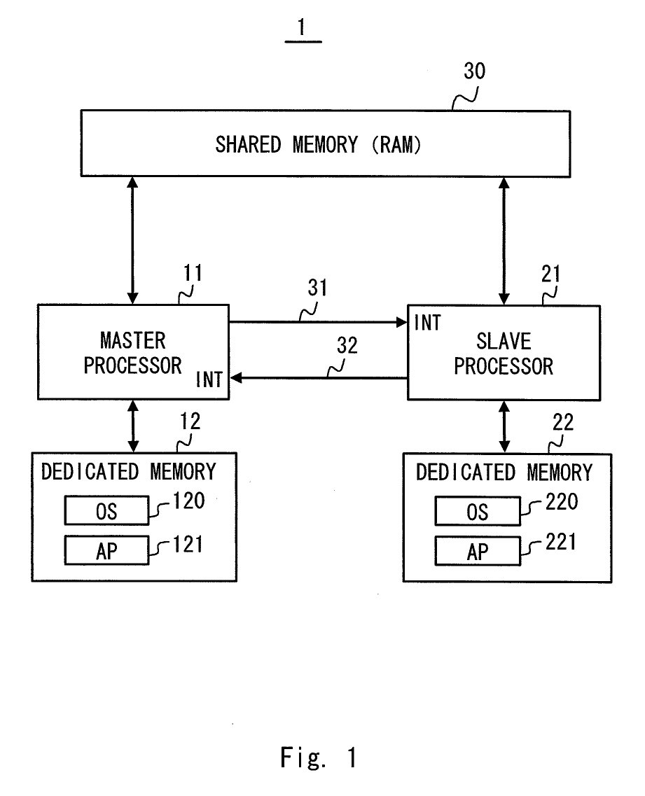

FIG. 1 is a block diagram showing the overall configuration of an information processing system 1 according to the exemplary embodiment. The information processing system 1 includes a master processor 11 and a slave processor 21. The master processor 11 and the slave processor 21 are connected through interrupt signal lines 31 and 32. The interrupt signal line 31 transfers an interrupt signal that causes an interrupt from the master processor 11 to the slave processor 21. On the other hand, the interrupt signal line 32 transfers an interrupt signal that causes an interrupt from the slave processor 21 to the master processor 11.

The master processor 11 and the slave processor 21 are capable of accessing a shared memory 30. The shared memory 30 is used as a data storage area for tasks to be executed in the master processor 11 and the slave processor 21. Further, the shared memory 30 is used for interprocessor communication between the master processor 11 and the slave processor 21.

A dedicated memory 12 is used as a storage area for an OS 120 and an application program (AP) 121 to be read and executed by the master processor 11 and as a storage area for data to be used by those programs.

The OS 120 is a program for controlling the master processor 11. The OS 120 executes task management for creating a multitasking environment in the master processor 11 with use of hardware resources such as the master processor 11, the dedicated memory 12 and the shared memory 30. The task management includes task status management, determination of execution sequence of tasks ready to be executed (i.e. task scheduling), and task dispatch by context saving and switching.

The AP 121 is a program for satisfying a user request. In the case where the information processing system 1 is incorporated into embedded equipment, the AP 121 is a program for implementing the function of the embedded equipment. The AP 121 contains a plurality of tasks that are divided based on a difference in hardware resources to use, time constraints and so on. Each of the plurality of tasks forming the AP 121 is executed on a multitasking environment that is provided by the master processor 11 and the OS 120. Although only one AP 121 is illustrated in FIG. 1 for simplification, the dedicated memory 12 may contain a plurality of APs for implementing various functions.

On the other hand, a dedicated memory 22 is used as a storage area for an OS 220 and an AP 221 to be read and executed by the slave processor 21 and as a storage area for data to be used by those programs. The OS 220 executes task management for creating a multitasking environment in the slave processor 21. The AP 221 is a program for satisfying a user request.

The configuration shown in FIG. 1 is just one example. The storage locations of the OS 120, the AP 121, the OS 220 and the AP 221, and a procedure to supply those programs to the master processor 11 or the slave processor 21 may be altered as appropriate. For example, the OS 220 for the slave processor 21 may be stored in the dedicated memory 12 which only the master processor 11 can access. In this case, the master processor 11 may load the OS 220 into the shared memory 30, and the slave processor 21 may read and execute the OS 220 loaded in the shared memory 30.

Hereinafter, an operation procedure when making a processing request from the master processor 11 to the slave processor 21 and an operation procedure in the slave processor 21 that has received the processing request are described in detail.

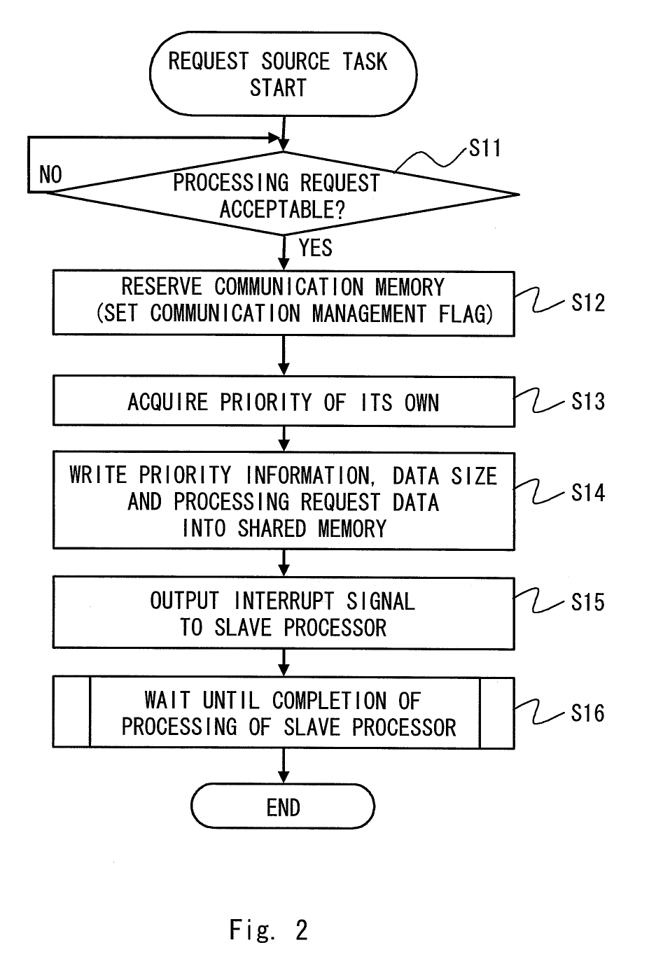

FIG. 2 is a flowchart showing a procedure to make a processing request from the master processor 11 to the slave processor 21. A task which is executed in the master processor 11 and makes a processing request to the slave processor 21 is referred to hereinafter as a “request source task”. In Step S11, it is determined whether transmission of a processing request to the slave processor 21 is possible. Specifically, it may be determined whether an available free space of the shared memory 30 is large enough for interprocessor communication, that is, whether it is large enough to store communication data containing a processing request.

If it is determined that a processing request to the slave processor 21 is acceptable (YES in Step S11), a memory area for interprocessor communication is reserved in Step S12. Specifically, a communication management flag is set in the memory space reserved in advance for interprocessor communication. The communication management flag is flag information indicating whether the area for storing communication data exchanged by interprocessor communication is in use or not.

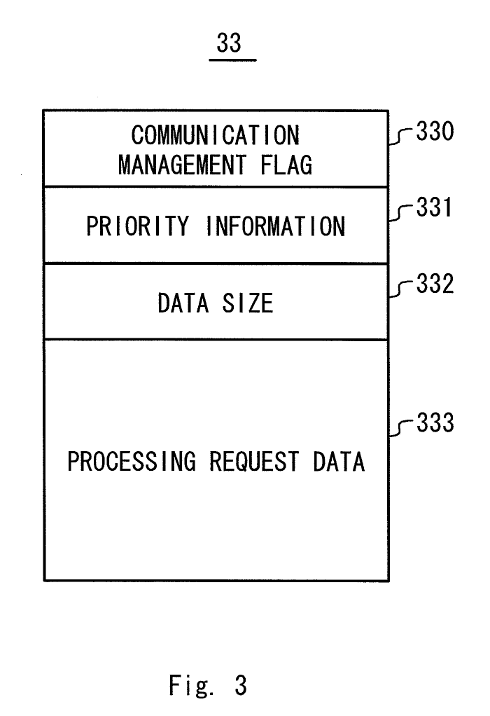

FIG. 3 shows a specific example of a data structure of communication data containing a communication management flag. Communication data 33 shown in FIG. 3 contains a communication management flag 330, priority information 331, a data size 332 and processing request data 333. As described above, the communication management flag 33 is flag information indicating whether the area for storing communication data exchanged by interprocessor communication is in use or not.

The priority information 331 is information for notifying the relative execution priorities of request source tasks in the master processor 11 to the slave processor 21. A specific value indicated by the priority information 331 may be an actual value of the execution priority of a request source task or another value associated with the execution priority of a request source task. Thus, the priority information 331 may be any information as long as it can notify the relative execution priorities of a plurality of request source tasks to the slave processor 21.

The data size 332 indicates a value for identifying the data size of the processing request data 333. A specific value of the data size 332 may be the data size of the processing request data 333 only or the data size of the communication data 33 as a whole including a header portion (i.e. the communication management flag 330, the priority information 331 and the data size 332) of the communication data 33.

The processing request data 333 is data transferred from the master processor 11 for processing in the slave processor 21.

Referring back to FIG. 2, in Step S13, the request source task acquires an execution priority that is set to itself. The acquisition of the execution priority may be performed by issuing a system call (service call) to the OS. Alternatively, if an access from the request source task to a register (not shown) in the master processor 11 which stores the status of created tasks is permitted, the execution priority may be acquired by reference to the register.

In Step S14, the master processor 11 writes the rest of the communication data 33 excluding the communication management flag 330 that has been set, which is, the priority information 331, the data size 332 and the processing request data 333, into the shared memory 30.

In Step S15, the master processor 11 outputs an interrupt signal to the interrupt signal line 31 in order to notify the occurrence of a processing request to the slave processor 21.

In Step S16, the request source task waits until processing of the slave processor 21 is completed. The request source task suspends execution and changes to “wait status”, and then sequentially changes to “ready status” and to “run status” in response to reception of an interrupt signal from the slave processor 21, which is described later, and finally confirms communication data indicating a processing completion result. The processing to change the operating status of the request source task to “ready status” in response to the occurrence of an interrupt from the slave processor 21 can be easily implemented by an interrupt handler that is activated upon occurrence of an interrupt. Further, the request source task may detect the completion of processing of the slave processor 21 by performing polling which periodically checks the communication management flag that is written to the shared memory 30 upon completion of processing of the slave processor 21.

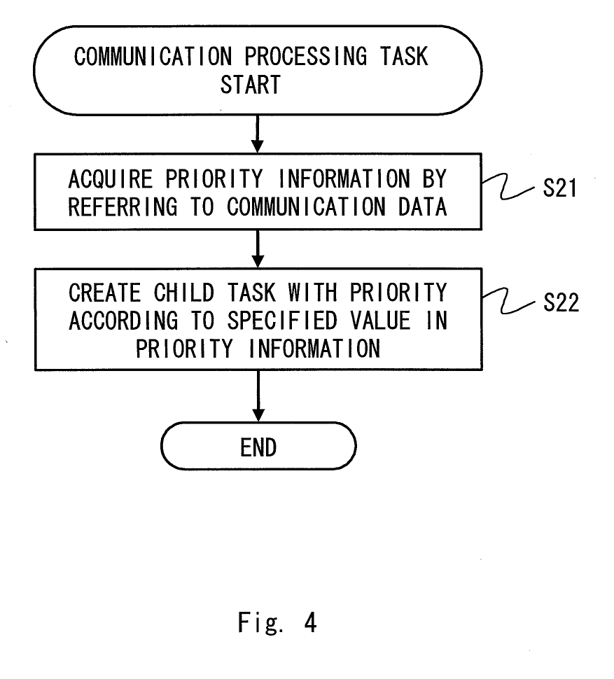

An operation procedure to accept a processing request in the slave processor 21 and a procedure to execute processing requested by the processing request are described hereinafter. FIG. 4 is a flowchart showing a processing procedure of a communication processing task that is activated in response to reception of an interrupt signal accompanying a processing request from the master processor 11. The activation of the communication processing task may be performed by an interrupt handler that is activated upon reception of an interrupt signal through the interrupt signal line 31. Specifically, the interrupt handler may notify the occurrence of a processing request to the communication processing task in “wait status”, change the communication processing task to “ready status”, and request task scheduling to the OS. It is preferred to give the highest execution priority in the slave processor 21 to the communication processing task in order that the communication processing task is executed preferentially.

In Step S21 of FIG. 4, the communication processing task acquires priority information by referring to the communication data written into the shared memory 30 by the master processor 11. In Step S22, the communication processing task creates a child task for executing processing requested by the processing request from the request source task. Upon completion of creating the child task, the communication processing task may notify a transition to “wait status” to the OS 220 and end the processing. The execution priority of the child task created in Step S22 is dynamically determined according to the execution priority of the request source task in the master processor 11 which is specified by the priority information. In other words, the execution priority of the child task in the slave processor 21 becomes higher as the execution priority of the request source task in the master processor 11 becomes higher.

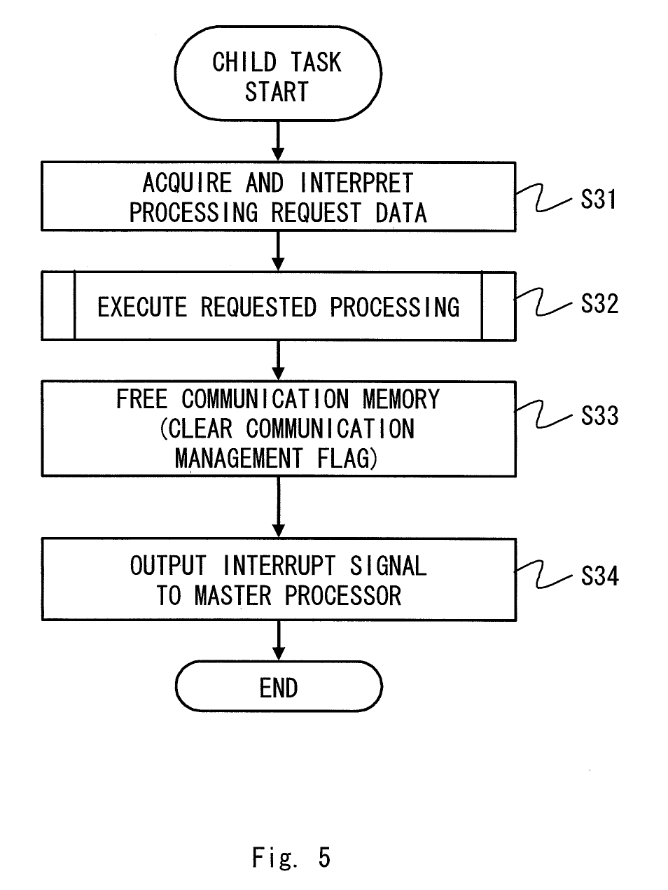

FIG. 5 is a flowchart showing a procedure that the child task created by the communication processing task executes processing based on the processing request from the request source task. In Step S31, the child task acquires processing request data from the shared memory 30 and interprets it. In Step S32, the child task executes the processing requested by the request source task. If the processing related to the processing request is completed, it frees the memory area for interprocessor communication which has been reserved by the request source task for transfer of the processing request data. Specifically, the communication management flag of the memory area may be cleared. In Step S34, the child task outputs an interrupt signal to the master processor 11 through the interrupt signal line 32 in order to notify completion of the processing. Upon completion of all the processing shown in FIG. 5, the child task notifies end of task to the OS 220. The OS 220 thereby terminates the child task and frees the memory area in which the task context of the child task has been stored.

The child task created by the communication processing task is executed on the slave processor 21 by task dispatch by the OS 220. As described earlier, the execution priority of the child task in the slave processor 21 is based on the execution priority of the request source task in the master processor 11. Accordingly, when a certain child task (which is referred to as a first child task) is in the run status, if a processing request is made from a second request source task with a higher execution priority than a request source task (which is referred to as a first request source task) of the first child task, the communication processing task with the highest execution priority is activated in the slave processor 21, and the execution of the first child task is suspended. Then, a child task (which is referred to as a second child task) for executing the processing request from the second request source task is created with a higher execution priority than the first child task by the communication processing task. Therefore, the second child task, not the first child task, is executed preferentially based on the task scheduling by the OS 220 performed after creation of the second child task.

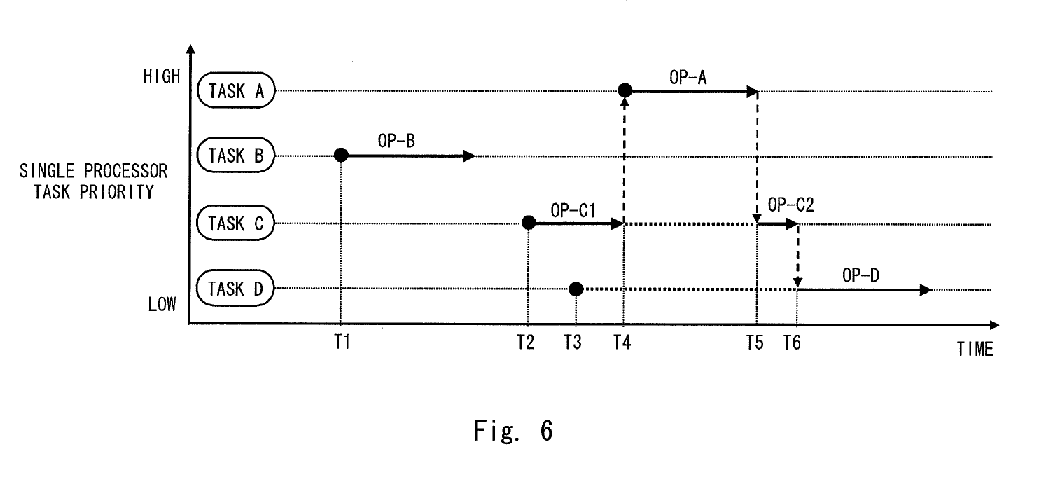

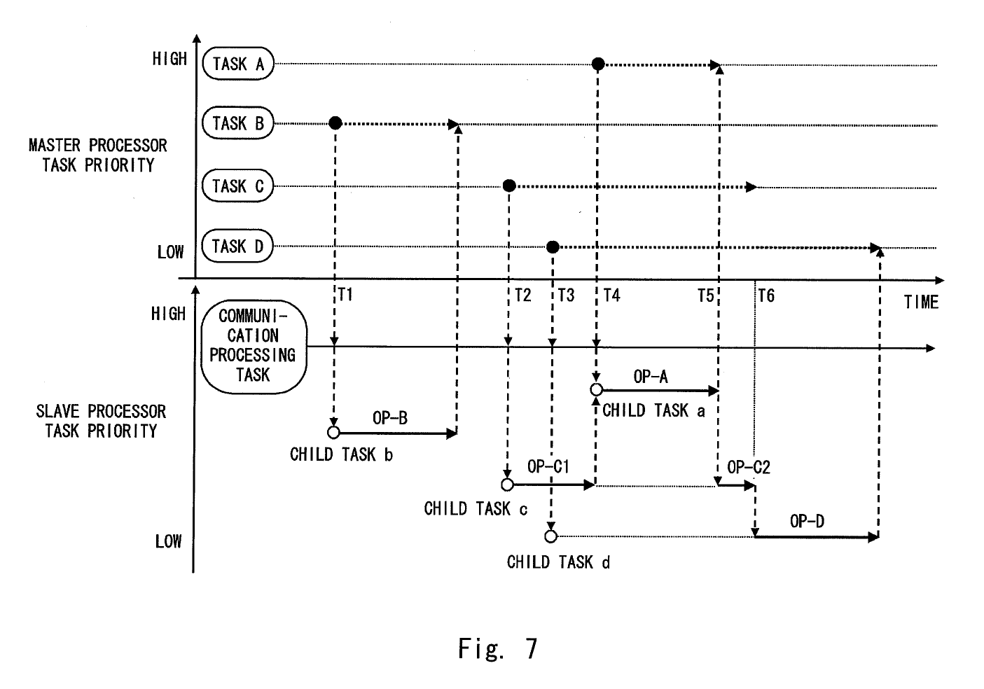

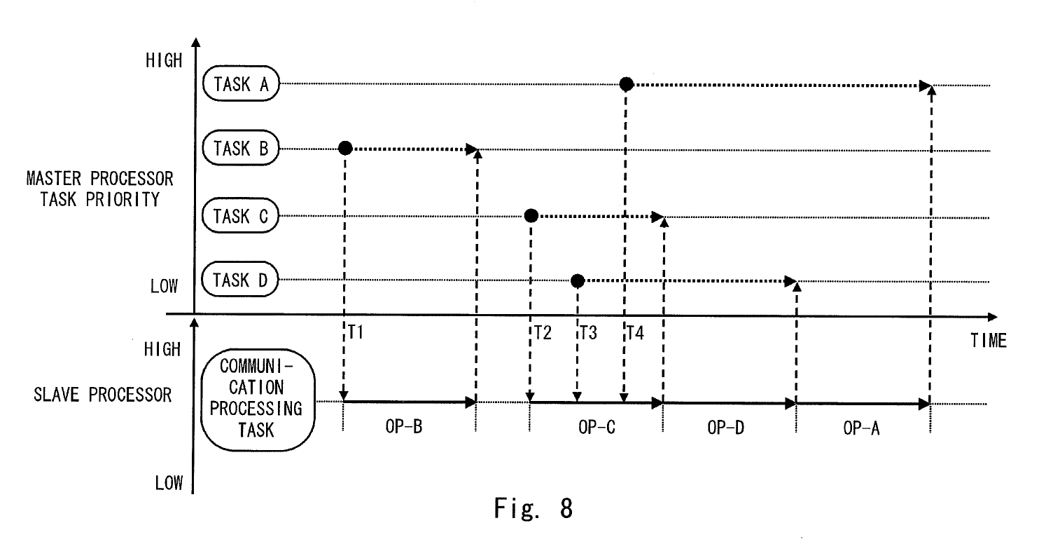

A transition process of execution tasks in the master processor 11 and the slave processor 21 is described hereinafter in detail with reference to FIGS. 6 and 7. FIG. 6 is a timing chart expected in the case where it is assumed that the information processing system 1 does not include the slave processor 21 and performs processing with a single processor. The timing chart of FIG. 6 corresponds to the timing chart shown in FIG. 8 according to related art. The execution priorities of four tasks A to D shown in FIG. 6 are allocated in such a way that it is highest for the task A and sequentially becomes lower in the order of the tasks B, C and D. The task B, which becomes ready at time T1, starts running without being affected by the other tasks because there is no other currently running task or ready task, and ends upon completion of processing (OP-B).

Next, the task C, which becomes ready at time T2, starts running because there is no other currently running task or ready task (OP-C1). Then, the task D becomes ready at time T3, which is during the running of the task C. The execution priority of the task D is lower than that of the task C. Thus, the task D does not start running until the other tasks with the higher execution priority than the task D end or those tasks release the rights to use the processor for some reason. When the task A becomes ready at time T4, the running of the task C with the lower execution priority is suspended, and the task A starts running instead (OP-A).

After that, when the task A ends at time T5, the execution priorities of all the tasks in the wait status, which are the task C and the task D, are compared. As a result of the comparison, the task C having the higher execution priority than the task D is selected, and the task C, which has been suspended, resumes running (OP-C2). When the task C ends at time T6, the task D starts running (OP-D), which has the lower execution priority than the other three tasks. As described above, the task scheduling based on the execution priorities of the tasks functions normally in the single processor, and a task execution sequence as intended by a software developer can be obtained, unlike the case shown in FIG. 8.

FIG. 7 is a timing chart showing a transition process of execution tasks in the master processor 11 and the slave processor 21 in the information processing system 1 according to the embodiment. The information processing system 1 is capable of executing the tasks in the same sequence as in the single processor shown in FIG. 6, in spite of a multiprocessor configuration. This is described in detail hereinbelow.

First, when a processing request is made from the task B, which is one of the request source tasks, at time T1 of FIG. 7, the communication processing task to which the highest execution priority is given is activated preferentially in the slave processor 21 in response to reception of an interrupt signal caused by the processing request. The communication processing task creates a child task b, which is a task that executes a processing request, based on the execution priority of the request source task B in the master processor 11. The child task b starts running immediately after the end of the communication processing task because there is no other child task (OP-B).

Next, when a processing request is made from the task C, which is one of the request source tasks, at time T2, the communication processing task creates a child task c in the slave processor 21. The child task c starts running immediately after the end of the communication processing task because there is no other child task (OP-C1).

Then, when a processing request is made from the task D, which is one of the request source tasks, at T3 during the running of the child task c, the communication processing task is activated and creates a child task d. The execution priority of the child task d in the slave processor 21 is set lower than the execution priority of the child task c, which is currently running. This is because the relative relationship of the execution priorities of the request source tasks C and D in the master processor 11 is reflected on the execution priorities of the child tasks c and d. Thus, the child task d does not start running until the other tasks with the higher execution priority than the child task d end or those tasks release the rights to use the slave processor 21 for some reason.

When a processing request is made from the task A, which is one of the request source tasks, at T4, the communication processing task is activated and creates a child task a. The execution priority of the child task a in the slave processor 21 is set higher than the execution priority of the child task c, which is currently running. Thus, the child task a is dispatched in place of the child task c by the task scheduling after the end of the communication processing task (OP-A).

When the child task a ends at time T5, the execution priorities of the child task c and the child task d both in the wait status are compared. As a result of the comparison, the child task c having the higher execution priority than the child task d is selected, and the child task c, which has been suspended, resumes running (OP-C2). Finally, when the child task c ends at time T6, the child task d having the lower execution priority than the other three child tasks starts running (OP-D).

As described above, the information processing system 1 according to the embodiment allows the execution sequence of a plurality of child tasks to perform processing related to processing requests in the slave processor 21 to coincide with the task execution sequence in the single processor shown in FIG. 6. A software developer can thereby perform design, development and testing without particular concern for the existence of interprocessor communication.

Further, the slave processor 21 activates the communication processing task in common for processing requests made from a plurality of different request source tasks and creates child tasks to execute the respective processing requests using the communication processing task. Therefore, it is not necessary for the slave processor 21 to create child tasks corresponding to a plurality of kinds of processing requests in advance. Accordingly, the slave processor 21 can avoid a waste of memory resources and OS resources for saving the task context, thus contributing to reduction of the device scale and the device cost of the embedded system.

The application of the present invention is not limited to the embedded system. The present invention is widely applicable to information processing systems in a multiprocessor configuration.

While the invention has been described in terms of several exemplary embodiments, those skilled in the art will recognize that the invention can be practiced with various modifications within the spirit and scope of the appended claims and the invention is not limited to the examples described above.

The information processing method shown in FIGS. 2, 4 and 5, can be turned into a computer program. This program can be stored in a known program storage device.

Further, the scope of the claims is not limited by the exemplary embodiments described above.

Furthermore, it is noted that, Applicant's intent is to encompass equivalents of all claim elements, even if amended later during prosecution.

What is claimed is:

1. An information processing system comprising:
a master processor; and
a slave processor, wherein
the master processor operates in a multitasking environment capable of executing a plurality of request source tasks for respectively making processing requests to the slave processor in parallel according to task scheduling based on execution priorities of the respective request source tasks,
the slave processor operates in a multitasking environment capable of executing a communication processing task for controlling communication with the master processor and child tasks created by the communication processing task for executing processing requested by the processing requests in parallel according to task scheduling based on execution priorities of the respective child tasks,
the processing requests contain priority information associated with the execution priorities of the request source tasks in the master processor,
the slave processor activates the communication processing task in common in response to the plurality of processing requests made from the plurality of different request source tasks, and
the communication processing task creates the child tasks with execution priorities allocated corresponding to the execution priorities of the request source tasks based on the priority information contained in the processing requests.

2. The information processing system according to claim 1, further comprising:
an interrupt signal line connecting the master processor and the slave processor; and
a shared memory used for interprocessor communication between the master processor and the slave processor, wherein
the master processor writes communication data containing the priority information into the shared memory and outputs an interrupt signal to the interrupt signal line when making a processing request to the slave processor, the slave processor activates the communication processing task in response to the interrupt signal input through the interrupt signal line, and
the communication processing task acquires the priority information from the communication data stored in the shared memory.

3. The information processing system according to claim 1, wherein
a higher execution priority is given to the communication processing task than to the child tasks, and the communication processing task is executed in preference to the child tasks in the slave processor.

4. The information processing system according to claim 1, wherein
a highest execution priority among a plurality of preset execution priorities is given to the communication processing task.

5. A task execution control method in an information processing system including a master processor and a slave processor, comprising:
transmitting communication data containing a processing request from a request source task executed in the master processor to the slave processor, the processing request containing priority information associated with an execution priority of the request source task in the master processor,
activating a communication processing task in the slave processor in response to reception of the communication data, the communication processing task being a task activated in common in response to reception of a plurality of communication data transmitted from a plurality of different request source tasks;
creating, by the communication processing task, a child task for executing processing requested by the processing request, the child task having an execution priority allocated corresponding to the execution priority of the request source task based on the priority information acquired from the communication data; and
executing the child task in the slave processor according to task scheduling based on execution priorities of a plurality of tasks including the child task.

6. The task execution control method according to claim 5, wherein
a higher execution priority is given to the communication processing task than to the child task, and the communication processing task is executed in preference to the child task in the slave processor.

7. The task execution control method according to claim 5, wherein
a highest execution priority among a plurality of preset execution priorities is given to the communication processing task.

8. A storage medium readable by a computer having a master processor and a slave processor, the storage medium storing therein a program which executes the steps of:
transmitting communication data containing a processing request from a request source task executed in the master processor to the slave processor, the processing request containing priority information associated with an execution priority of the request source task in the master processor,
activating a communication processing task in the slave processor in response to reception of the communication data, the communication processing task being a task activated in common in response to reception of a plurality of communication data transmitted from a plurality of different request source tasks;
creating, by the communication processing task, a child task for executing processing requested by the processing request, the child task having an execution priority allocated corresponding to the execution priority of the request source task based on the priority information acquired from the communication data; and
executing the child task in the slave processor according to task scheduling based on execution priorities of a plurality of tasks including the child task.
